(19) United States
(12) Patent Application Publication
(10) Pub. No.: US 2007/0235562 A1
(43) Pub. Date: Oct. 11, 2007

(54) Water shutoff and discharge control apparatus for use of sprinkling

(75) Inventor: Shun Nan Lo, Changhua Hsien (TW)

Correspondence Address: TROXELL LAW OFFICE PLLC;SUITE 1404, 5205 LEESBURG PIKE, FALLS CHURCH, VA, 22041, US

(73) Assignee: YUAN MEI CORP.

(21) Appl. No.: 11/481,972

(22) Filed: Jul. 7, 2006

(30) Foreign Application Priority Data
Mar. 24, 2006 (TW) 095110269

(51) Int. Cl. A62C 31/02

(52) U.S. Cl. 239/390

(57) ABSTRACT

A water-shutoff and discharge control apparatus for use of sprinkling comprises a valve body and a rotary sleeve. The valve body has a water-enclosed surface disposed therein to divide a water-intake chamber and a water-outlet chamber, and a curved-extending positioning groove indented at the periphery thereon for the accommodation of a watertight hoop. Outlet and inlet orifices are provided to fluidly connect to the water-intake chamber and the water-outlet chamber respectively. The rotary sleeve, mounted to the valve body and sealed watertight thereto at both ends, has a water-sealing area and water-outlet ducts disposed therein to match to the curved line of the watertight hoop, permitting the water-sealing area to completely abut against the watertight hoop. Therefore, the rotary sleeve is simply rotated to shift the positions of the water-sealing area and the water-outlet ducts gradually switching from the watertight hoop for easy control of water shutoff and discharge thereby.

### BACKGROUND OF THE INVENTION

The present invention relates to a water shutoff and discharge control apparatus for use of sprinkling, comprising a valve body and a rotary sleeve wherein the rotary sleeve has a water-sealing area and multiple water-outlet ducts defining both sides of the internal wall thereon to match to the curved line of a watertight hoop accommodated to a positioning groove defining the external surface of the valve body thereon; whereby the rotary sleeve is simply rotated to shift the positions of the water-sealing area and the water-outlet ducts gradually switching from the watertight hoop in a sequence so as to control the amount of water supply discharged, achieving the purpose of fine-tuning in an easy manner as well as reducing the assembly parts and the cost of production for economical efficiency thereof.

“Manually-adjusting Control Apparatus for a Long-handled Spray Gun”, a Taiwan patent with the Publication No. 543510, is operated by way of manual pushing to control the spray and the amount of water supply discharged, and is characterized by a complicated structure with numerous assembly parts applied thereto. As a result, the cost of material and production of such a conventional water discharge control apparatus is relatively high, and the assembly thereof is rather complicated and time-consuming in an uneconomical manner. Besides, in operation, a press handle must be continuously pushed for the discharge of water flow, and an adjusting button must be applied to regulate the amount of water discharge, which is rather inconvenient in operation.

### SUMMARY OF THE PRESENT INVENTION

It is, therefore, the primary purpose of the present invention to provide a water shutoff and discharge control apparatus for use of sprinkling, comprising a valve body and a rotary sleeve wherein the interior of the valve body is divided into a water-intake chamber and a water-outlet chamber that are matched to a curved-line winding watertight hoop accommodated to the external surface of the valve body thereof, and the rotary sleeve is equipped with a water-sealing area and multiple water-outlet ducts that are conjoined in an identical curvature to fit to the watertight hoop thereof, providing a simple design to control the discharge and shutoff of water supply in an easy manner as well as reducing the complicated assembly parts of the above-mentioned prior art for speedy assembly to achieve the economical efficiency thereby.

It is, therefore, the second purpose of the present invention to provide a water shutoff and discharge control apparatus for use of sprinkling wherein the conjoining section of the water-sealing area and the water-outlet ducts of the rotary sleeve, and the watertight hoop of the valve body are identically molded in curved line so that the rotary sleeve is simply rotated to shift the positions of the water-sealing area and the water-outlet ducts relative to that of the watertight hoop thereof to control the shutoff and discharge of water supply, facilitating simpler and easier operation thereby.

It is, therefore, the third purpose of the present invention to provide a water shutoff and discharge control apparatus for use of sprinkling wherein the rotary sleeve is simply rotated to shift the positions of the water-sealing area and the water-outlet ducts gradually switching from the watertight hoop in a sequence so as to control the amount of water supply discharged, achieving the purpose of fine-tuning in an easy manner.

### BRIEF DESCRIPTION OF THE DRAWINGS

FIG. 1 is an exploded perspective view of the present invention.

FIG. 2 is a perspective view of a valve body and a rotary sleeve of the present invention.

FIG. 3 is an assembled cross sectional view of the present invention.

FIG. 4 is a diagram showing a water-sealing area of the rotary sleeve completely sealed to a watertight hoop of the valve body thereof in a water shutoff state.

FIG. 5 is a diagram showing the rotary sleeve rotated to the position with water-outlet ducts located over the watertight hoop of the valve body thereof in a state of water discharge.

FIG. 6 is a diagram showing the present invention assembled onto a long-handled spray device.

FIG. 7 is another diagram showing the present invention assembled onto another long-handled spray device.

FIG. 8 is an exploded perspective view of another embodiment of the present invention.

FIG. 9 is an assembled cross sectional view of the present invention shown in FIG. 8.

### DETAILED DESCRIPTION OF THE PREFERRED EMBODIMENTS

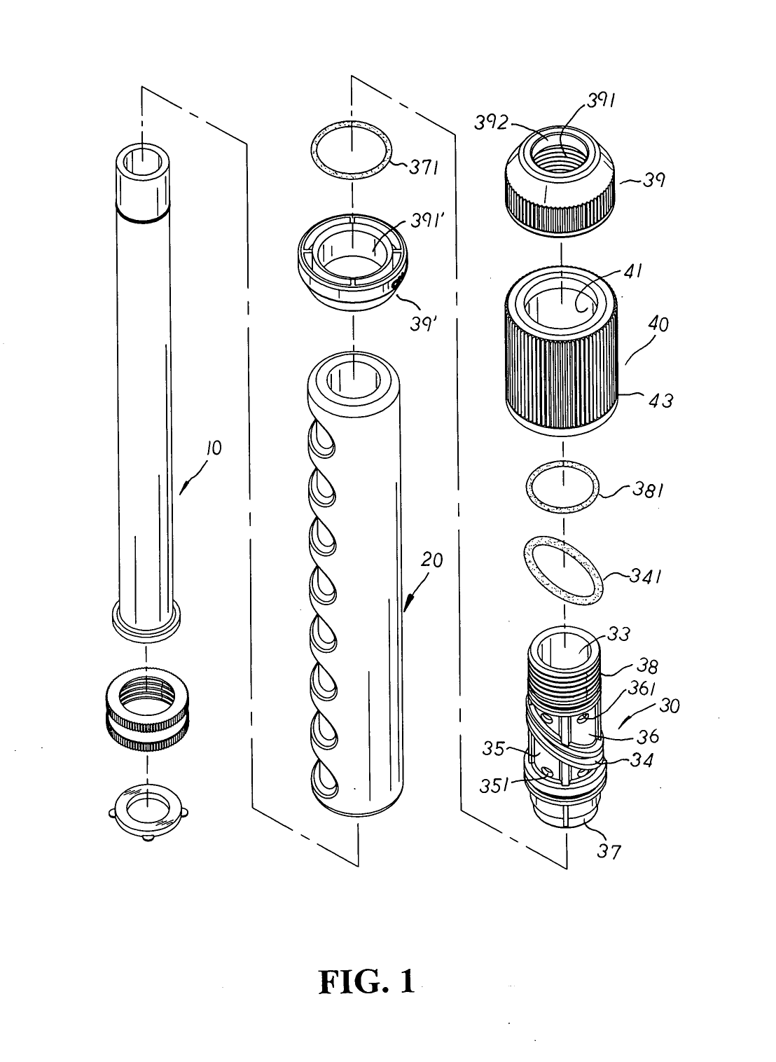

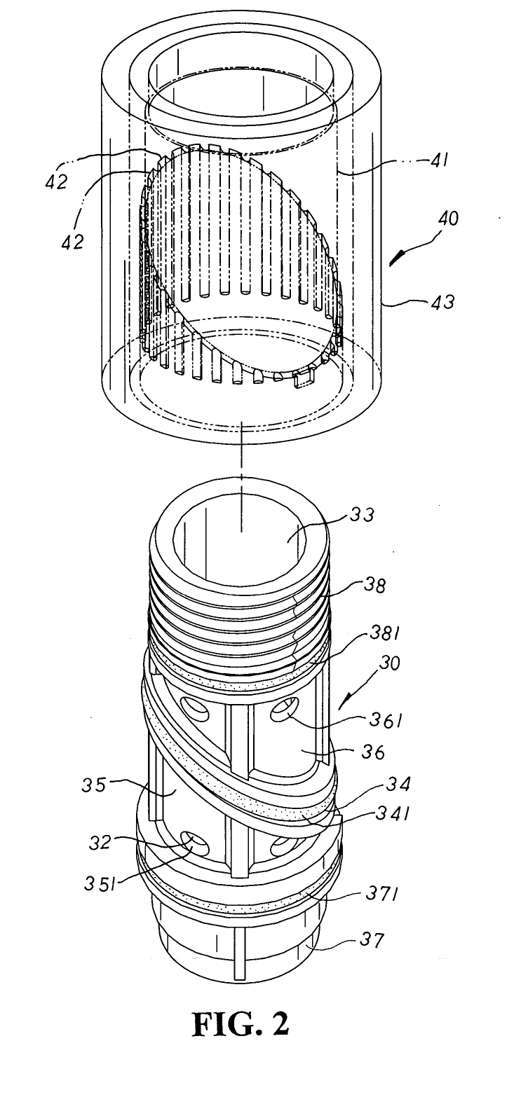

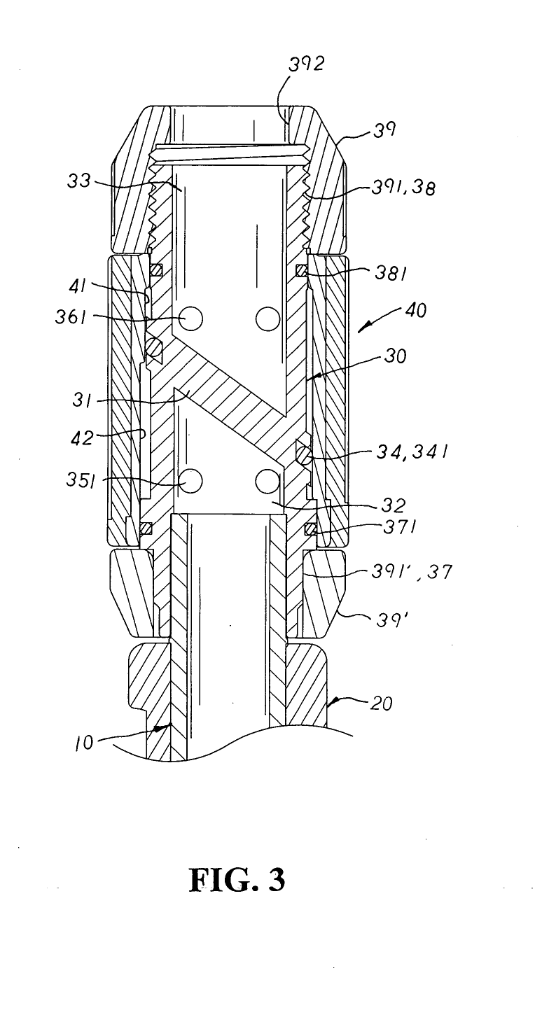

Please refer to FIG. 1 showing an exploded perspective view of the present invention (accompanied by FIGS. 2, 3). The present invention relates to a water shutoff and discharge control apparatus for use of sprinklers, comprising a water intake tube 10, an anti-slippery grip 20 sleeved to the outer periphery of the water-intake tube 10, and a valve body 30 with a rotary sleeve 40 cooperatively matched to the water intake tube 10 therewith. The valve body 30 has an interior divided by an oblique sloped water-enclosed surface 31 to form a water-intake chamber 32 and a water-outlet chamber 33 at both sides therein, and an exterior defined by an oblique annularly-extending positioning groove 34 that curves in the position relative to the water-enclosed surface 31 disposed therein for the accommodation of a watertight hoop 341 thereto. And the positioning groove 34 appropriately divides an outlet groove seat 35 with outlet orifices 351 disposed thereon at one side and an inlet groove seat 36 with inlet orifices 361 disposed thereon at the other side thereof. The outlet orifices 351 are fluidly connected to the water-intake chamber 32, and the inlet orifices 361 thereof are fluidly connected to the water-outlet chamber 33 thereof. One end of the valve body 30 is also equipped with an assembling section 37 having a water-sealing ring 371 mounted thereto to couple with the water-intake tube 10, permitting the water-intake chamber 32 to fluidly connect to the water-intake tube 10 thereby. The other end of the valve body 30 is provided with a locking section 38 having a waterproof ring 381 mounted thereto to reciprocally secure to a locked section 391 defining the interior of a stop cap 39 therewith. The stop cap 39 has a bore 392 disposed in the middle thereof communicating with the water-outlet chamber 33 of the valve body 30 to form a water discharge end thereby. The rotary sleeve 40 is mounted to the outer periphery of the valve body 30, and both ends of the rotary sleeve 40 are precisely sealed tight onto the water-sealing ring 371 and the waterproof ring 381 respectively, permitting an enclosed space to form between the internal wall of the rotary sleeve 40 and the valve body 30 thereby. At one side of the internal wall of the rotary sleeve 40 is disposed a smooth-surfaced water-sealing area 41 extending from bottom to top in an oblique circle along the curved line of the watertight hoop 341 thereof. And the other side of the internal wall of the rotary sleeve 40 has a plurality of water-outlet ducts 42 arranging sequentially from bottom to top to conjoin with the curved line of the water-sealing area 41 respectively. The water-sealing area 41 and each water-outlet duct 42 are kept from the outlet and inlet groove seats 35, 36 of the valve body 30 in an appropriate spacing respectively. The water-sealing area 41 is precisely abutted close against the watertight hoop 341 relative to the position of the water-outlet chamber 33 thereof, and the water-outlet ducts 42 are situated at one side of the watertight hoop 341 relative to the position of the water-intake chamber 32 thereof. A limiting cap 39′ with a hole 391′ defining thereon is provided to couple with the assembling section 37, permitting both ends of the rotary sleeve 40 to abut against the stop cap 39 and the limiting cap 39′ there-between. And an anti-slippery covering 43 with a plurality of protrusive ribs thereon is mounted to the outer periphery of the rotary sleeve 40 thereon.

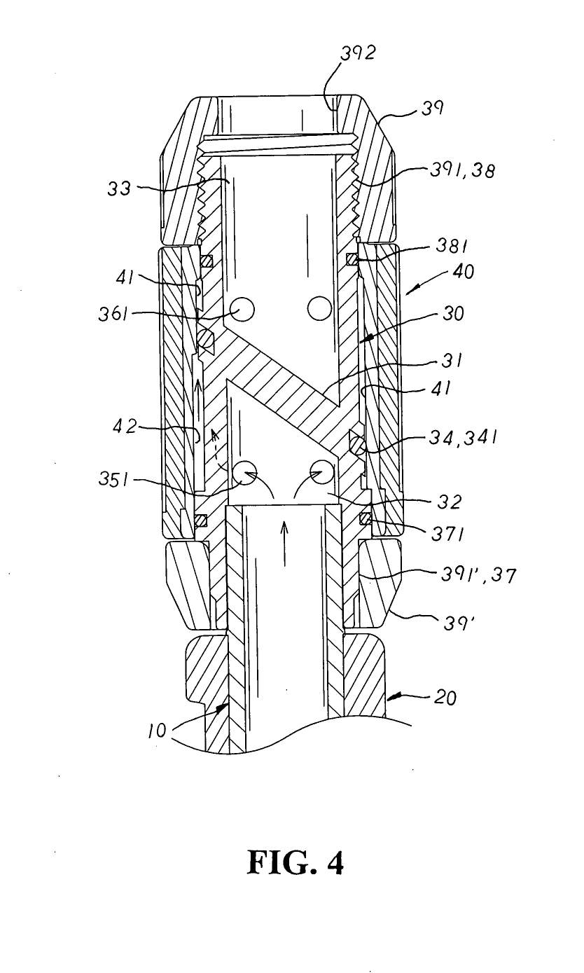

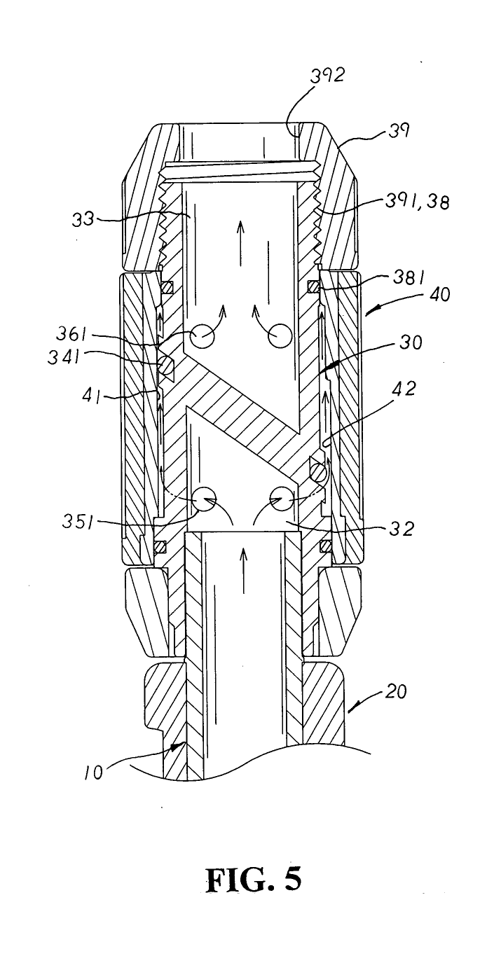

Please refer to FIG. 4. When water flow passes through the water-intake tube 10 to enter the water-intake chamber 32 of the valve body 30, the water flow will be stopped by the water-enclosed surface 31 to flow outwards through each outlet orifice 351 thereby. Meanwhile, the water-sealing area 41 of the rotary sleeve 40 is completely sealed onto the watertight hoop 341 of the valve body 30 to cut off the passage of the water flow, permitting the water flow to collect among each water-outlet duct 42 and the outlet groove seat 35 therein and form a water shutoff state thereby. Then, one end of the rotary sleeve 40 is closely abutted against the water-sealing ring 371 of the valve body 30 to avoid the risk of water leakage when the water supply is shut off from discharge. In application, the rotary sleeve 40 is simply rotated to one side. Due to the curved-line design of the water-sealing area 41, the water-outlet ducts 42, and the watertight hoop 341 thereof, the water-sealing area 41 and the water-outlet ducts 42 will be shifted in positions to switch from the watertight hoop 341 according to the spinning radian thereof, permitting the watertight hoop 341 to gradually detach from the water-sealing area 41 and locate among part of the water-outlet ducts 42 thereof. Then, part of the water-outlet ducts 42 thereof can be fluidly connected to both outlet and inlet groove seats 35, 36 situated at both sides of the watertight hoop 341 thereof. Thus, the water flow can be transported via the water-outlet ducts 42 to enter the inlet groove seat 36 and pass through the inlet orifices 361 before flowing into the water-outlet chamber 33 to be discharged outwards there-from as shown in FIG. 5. Meanwhile, the other end of the rotary sleeve 40 is closely sealed onto the waterproof ring 381 thereof so as to prevent the risk of water leakage in the state of water discharge. Besides, depending on the different radians of the rotary sleeve 40 switched, the present invention can easily achieve the purpose of fine-tuning so as to regulate the amount of water discharge in an accurate manner.

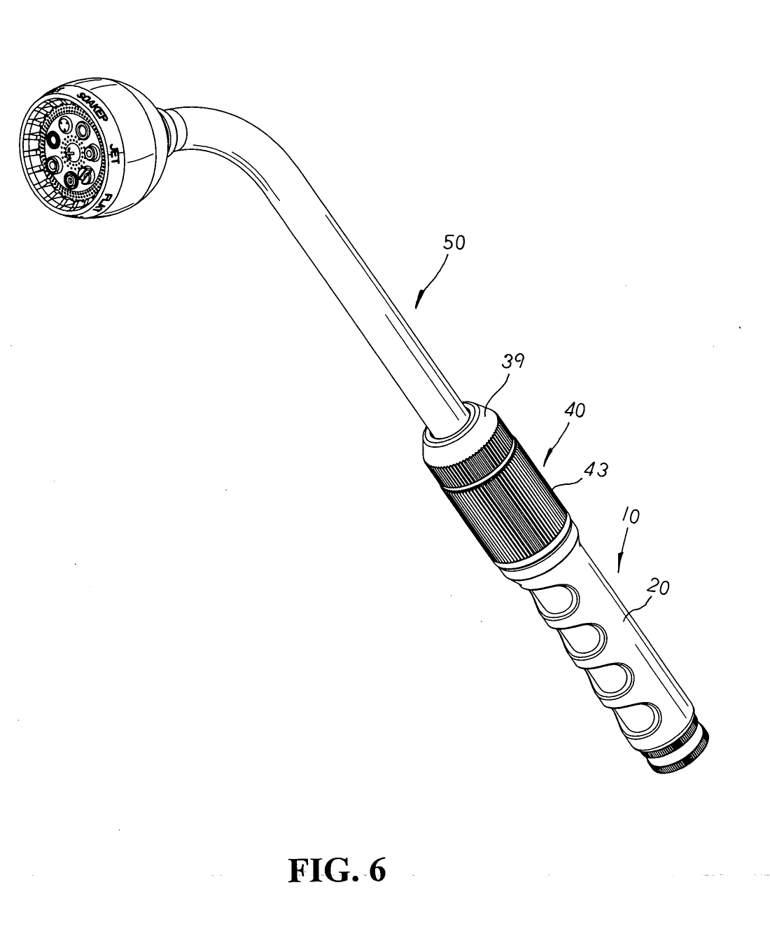

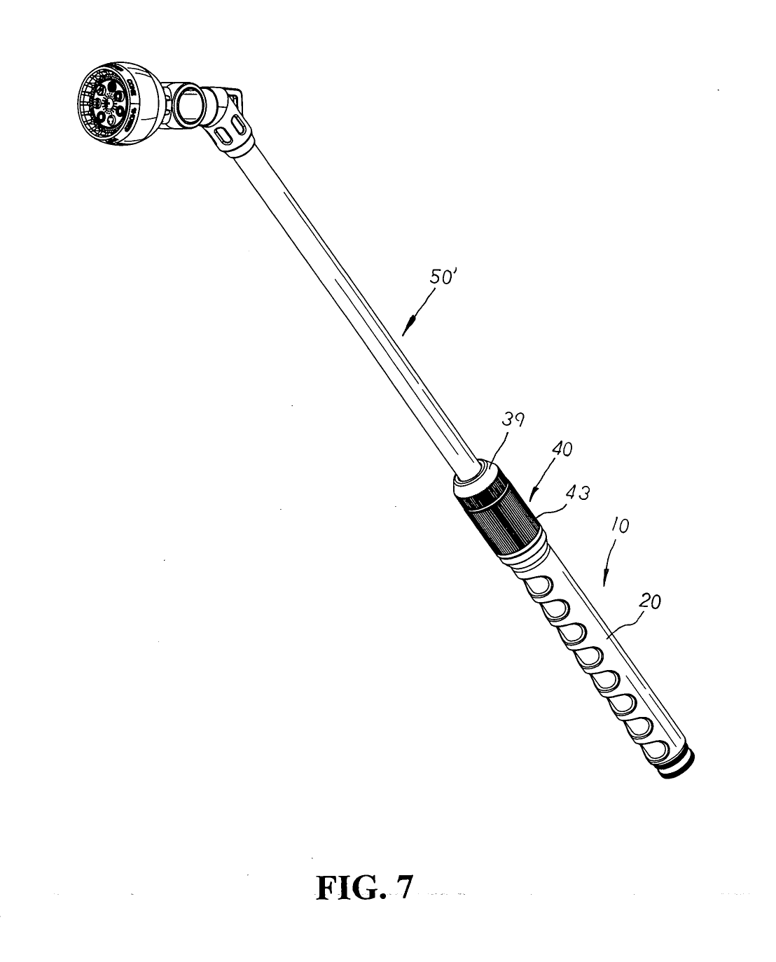

Please refer to FIGS. 6, 7. The bore 392 of the stop cap 39 and the locking section 38 of the valve body 30 can be joined to long-handled spray devices 50, 50′ with various-type nozzles attached thereto.

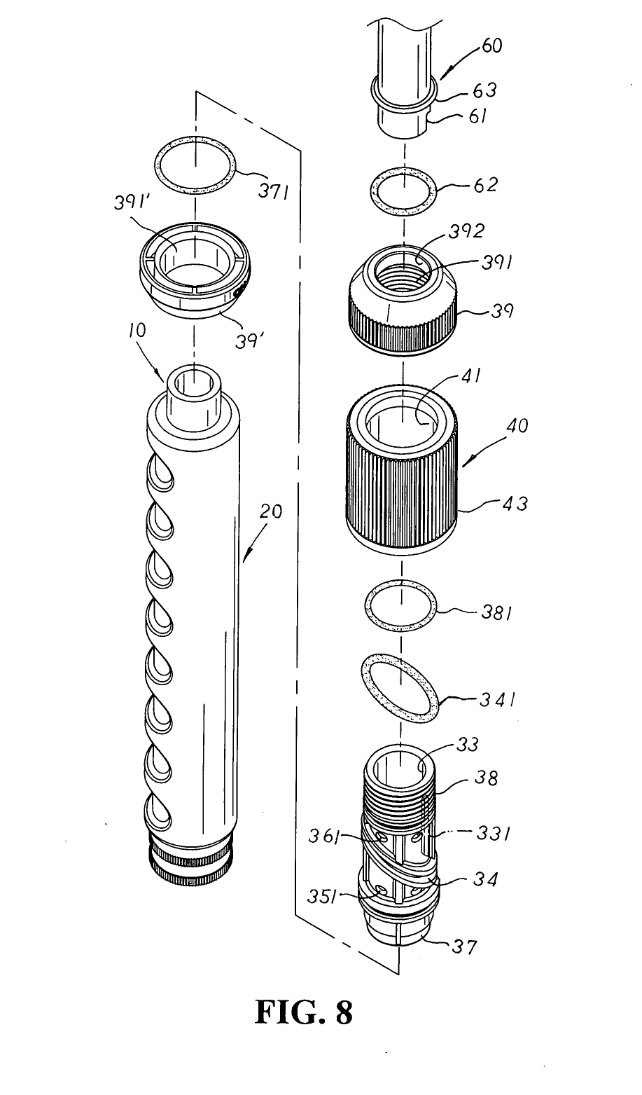

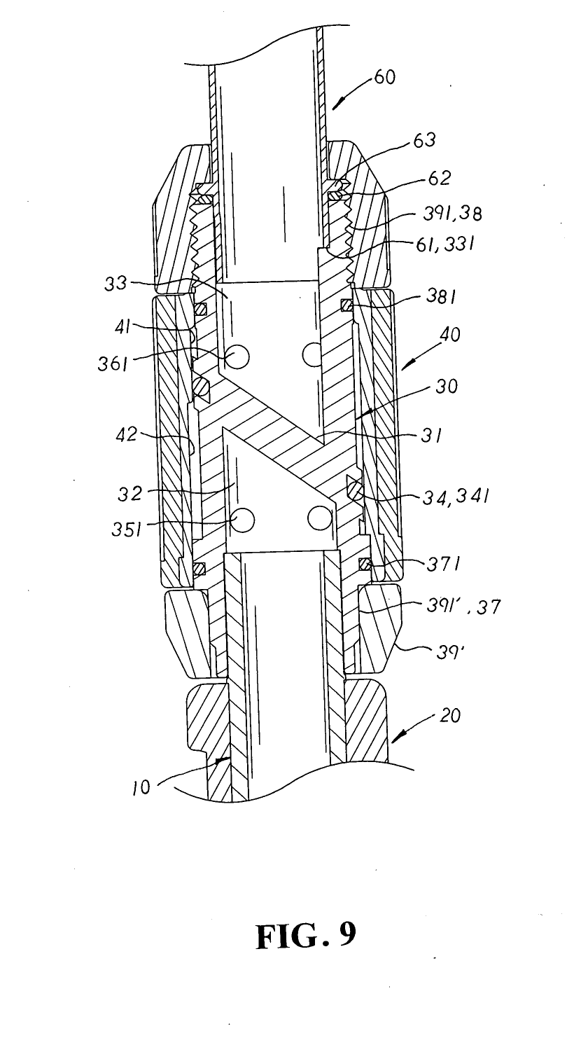

Please refer to FIGS. 8, 9. The water-outlet chamber 33 of the valve body 30 can also have an insert rib 331 protruding on the internal surface thereon for secure engagement of a cavity 61 defining one end of an outlet connecting head or outlet connecting tube 60 therewith. Besides, the outer periphery of the outlet connecting tube 60 has a stop seat 63 with a sealing ring 62 mounted thereto that is secured tight by the stop cap 39 to abut closely against the opening end edge of the water-outlet chamber 33 thereby.

What is claimed is:

1. A water shutoff and discharge control apparatus for use of sprinkling, comprising a valve body and a rotary sleeve wherein the valve body has an interior divided by a water-enclosed surface to form a water-intake chamber and a water-outlet chamber at both sides therein, and an exterior defined by a curved-line extending positioning groove for the accommodation of a watertight hoop thereto; one side of the positioning groove thereof has a plurality of outlet orifices disposed thereon to fluidly connect to the water-intake chamber thereof, and the other side of the positioning groove is disposed a plurality of inlet orifices to fluidly connect to the water-outlet chamber thereby; the rotary sleeve is mounted to the outer periphery of the valve body, and both ends of valve body are respectively equipped with a water-sealing ring and a waterproof ring that are securely joined watertight to the internal surface of the rotary sleeve thereby; at both sides of the internal wall of the rotary sleeve are respectively equipped with a smooth-surfaced water-sealing area and a plurality of water-outlet ducts that are reciprocally conjoined to each other in the position relative to the curved line of the watertight hoop accommodated in the positioning groove thereof, permitting the water sealing area to precisely extend along the curved line of the positioning groove and completely seal onto the watertight hoop thereby;
therefore, when water supply entering the water-intake chamber of the valve body is stopped by the water-enclosed surface to flow outwards through the outlet orifices thereby, the water flow will be restricted by the water-sealing area and the watertight hoop of the valve body to collect at each water-outlet duct and form a water shutoff state thereby; then the rotary sleeve is simply rotated to one side, permitting the water-sealing area and the water-outlet ducts to shift in positions according to the spinning radian and gradually switch from the watertight hoop thereby; thus, part of the water-outlet ducts are allowed to fluidly connect to both outlet and inlet orifices so that the water flow can be transported via the water-outlet ducts to pass through the inlet orifices and enter the water-outlet chamber of the valve body to be discharged outwards there-from.

2. The water shutoff and discharge control apparatus for use of sprinkling as claimed in claim 1 wherein one end of the valve body can be mounted to a long-handled spray device with various-type nozzles attached thereto, while the other end of the valve body is coupled to a water-intake tube.

3. The water shutoff and discharge control apparatus for use of sprinkling as claimed in claim 2 wherein the water-intake tube can have an anti-slippery grip sleeve-joined to the outer periphery thereon.

4. The water shutoff and discharge control apparatus for use of sprinkling as claimed in claim 1 wherein the valve body can have the water-intake tube attached at one end thereon, and various-type outlet connecting heads and outlet connecting tubes coupled at the other end thereon.

5. The water shutoff and discharge control apparatus for use of sprinkling as claimed in claim 1 wherein the water-outlet chamber of the valve body can also have an insert rib protruding on the internal wall thereon for secure engagement of a cavity defining one end of various-type outlet connecting head or tubes therewith; besides, the outer periphery of the outlet connecting tube is disposed a stop seat with a sealing ring attached thereto to abut closely against the opening end edge of the water-outlet chamber thereby.

6. The water shutoff and discharge control apparatus for use of sprinkling as claimed in claim 1 wherein the water-enclosed surface of the valve body can be shaped into an oblique sloped configuration to reciprocally match to the watertight hoop thereof.

7. The water shutoff and discharge control apparatus for use of sprinkling as claimed in claim 1 wherein the positioning groove of the valve body and the conjoining section of the water-sealing area and the water-outlet ducts of the rotary sleeve can be shaped into an oblique and curved-line configuration.

8. The water shutoff and discharge control apparatus for use of sprinkling as claimed in claim 1 wherein one end of the valve body is equipped with an assembling section having a water-sealing ring mounted thereto to couple with the water-intake tube thereby, and the other end of the valve body is provided with a locking section having a waterproof ring mounted thereto to reciprocally secure to a locked section defining the interior of a stop cap therewith.

9. The water shutoff and discharge control apparatus for use of sprinkling as claimed in claim 8 wherein a limiting cap with a hole defining thereon can be mounted to the assembling section of the valve body thereof.
